(19) United States
(12) Patent Application Publication
(10) Pub. No.: US 2006/0285657 A1
(43) Pub. Date: Dec. 21, 2006

(54) Predictive automatic voice response systems

(76) Inventors: David Lowell Lippke, Bluemont, VA (US); Chris Nicotra, Ashburn, VA (US); Keith Bunker Jenkins, Leesburg, VA (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/142,040

(22) Filed: May 31, 2005

(51) Int. Cl. H04M 1/64

(52) U.S. Cl. 379/67.1

(57) ABSTRACT

An automated voice response system is provided that determines the most likely reason a caller is using the response system and, without any input from the user, provides the user with a predictive message. As such, the average call time for users of the voice response system is decreased. As in one example, the telephone number used to call the voice response system can be utilized to determine if the caller has an account with a service or product associated to the voice response system. The voice response system can then scan to see if there is a problem with the account that the user. Extending this example, a user that is at home waiting since 4 pm for a cable repairman may be presented with the predictive message “your repairman is running 2 hours late and will be at your house at 6 pm” the moment the caller connects to the voice response system.

### BACKGROUND OF THE INVENTION

This invention relates to automated voice response systems.

People occasionally use the telephone as a way to gather information from a variety of sources. Traditionally, customer service representatives were utilized to interact with, and supply information to, people that desired information from a company. Manual interaction with customers, however, is costly and time consuming.

Static automated response systems have been developed. Such systems have pre-recorded menu options that are provided to a user in a pre-determined order.

Alternatively, a caller may request, through a pre-determined menu, information from the automated response system. For example, a caller may select the menu option “account balance” in order to obtain information about the callers account balance. In turn, the automated response system may request that the user enter in the caller's account number. After the automated response system has received the user's account number, the system can retrieve the information specifically requested by the caller (i.e., the user's account balance).

Traditional manual and automated systems are insufficient. For one, both systems are slow. Manual systems are at a disadvantage because a person takes more time entering in an account number than a computer does. Moreover, in order to create a “waitless” answering environment, a company must employ a number of customer service equal to the number of people calling at any one time. Additionally, a caller may have to wait through multiple strings of pre-recorded menu options before the caller is provided with the desired option. The longer that customers remain on the phone, the larger the chance that the phone system will reach maximum capacity. It is therefore desirable to provide a low cost automated voice response system that decreases the amount of time needed to satisfy a caller's reason for calling.

### SUMMARY OF THE INVENTION

A predictive automated voice response system is provided that attempts to predict the particular reason that a caller is calling so that the caller can be presented with an answer to question the caller is most likely trying to have answered. This answer is preferably provided before a caller enters input (e.g., before the system provides an opportunity to the caller to enter a data input such as a menu option selection). As such, the answer can be transmitted to a caller prior to accepting inputs from that caller (e.g., before the caller asks the question). Alternatively, the system can provide a navigational shortcut to the menu option that the caller is most likely trying to reach.

The system may perform an initial identification of a caller by obtaining the phone number that the call originated from. This may be accomplished, for example, by looking at the position in the call's data stream associated to the originating phone number.

Using the caller's telephone number, additional information about the user may be retrieved. Accordingly, the system may determine the most likely reason that a caller is calling based on the information associated to the caller's identification. For example, an event-based predictive response system may utilize the caller's telephone number to obtain account information associated to that telephone number. As such, the system can search for recent events that are associated to the caller's account. Events can take many forms including, for example, potential problems with the account. For example, a caller may call a wireless service provider and receive the predictive message “your service was deactivated at 11 pm today for failure to pay a balance of $4,125.12” without providing any direct input to the system. Accordingly, the system may also provide a menu option associated to the predictive message. Continuing the above example, the system may then provide a predictive menu option stating “press 1 to pay your $4,125.12 balance.”

A predictive system is also provided that can deliver a predictive response to first-time callers that do not have account information on file. For example, a first time caller may call from the phone number (914)123-4567. Even though the system may not have any information related to the number (914)123-456, the system can determine, using third party information, that the call originated from Westchester, N.Y., belongs to a mobile telephone, and is serviced by Sprint, Inc. Accordingly, the predictive response system may retrieve information in a local or remote database associated to, for example, the caller's location to see if there is a probable reason as to why a person would call from that location. In this manner, a cable company can provide an initial predictive message related to such geographical information stating “μl cable service is down in Westchester as a result of lighting striking Westchester's routing facility.” As per another example, Nextel, Inc., could provide a predictive message to a user based on the wireless service provider stating “Nextel currently does not allow telephone numbers to be transferred from Sprint phones to Nextel phones.” Thus, a predictive message can be generated for a user that does not have an account on file based on information regarding the caller's phone number itself.

A predictive messaging system is also provided that is dynamic in nature—changing the way information is presented to a user throughout the system's interaction with a user. For example, suppose that a caller remains on a call after an initial predictive message is provided to a user. Instead of delivering a traditional option menu, the user may be presented with a dynamic options menu. The configuration of the dynamic option menu may be based on information associated to the user's profile. One type of information the system can utilize is a caller's prior selection behavior. Accordingly, the system can organize (e.g., rank) the menu options based on the popularity of the options to the caller in the past.

Similarly, the system can present menu options to a first-time caller based on the popularity of menu options to all callers. Such a system can rank menu options based on the all-time popularity or the popularity during a period of time (e.g., the last hour). Such a system is capable of handling calling spikes associated to events that are unknown to the system. For example, suppose that ten different websites use the same response system and that one of these websites goes down. Now, suppose that the response system does not detect (or is not made aware of) the failure. A periodic dynamic response system can provide either a dynamic option menu based on global activity in the last hour stating “to note a technical problem for site X, press 1” or a predictive message may be generated that states “caller activity suggests that a problem may exist with site X based on a number of callers reporting technical problems with site X.”

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a flow chart of a predictive voice response system constructed in accordance with the principles of the present invention;

FIG. 2 is a network topology of a voice response system network constructed in accordance with the principles of the present invention;

FIG. 3 is a flow chart of an event-based messaging system constructed in accordance with the principles of the present invention;

FIG. 4 is a flow chart of an event-based messaging system constructed in accordance with the principles of the present invention;

FIG. 5 is a network topology of an event-based messaging system constructed in accordance with the principles of the present invention; and

FIG. 6 is a flow chart of a dynamic menu options process constructed in accordance with the principles of the present invention.

### DETAILED DESCRIPTION OF THE INVENTION

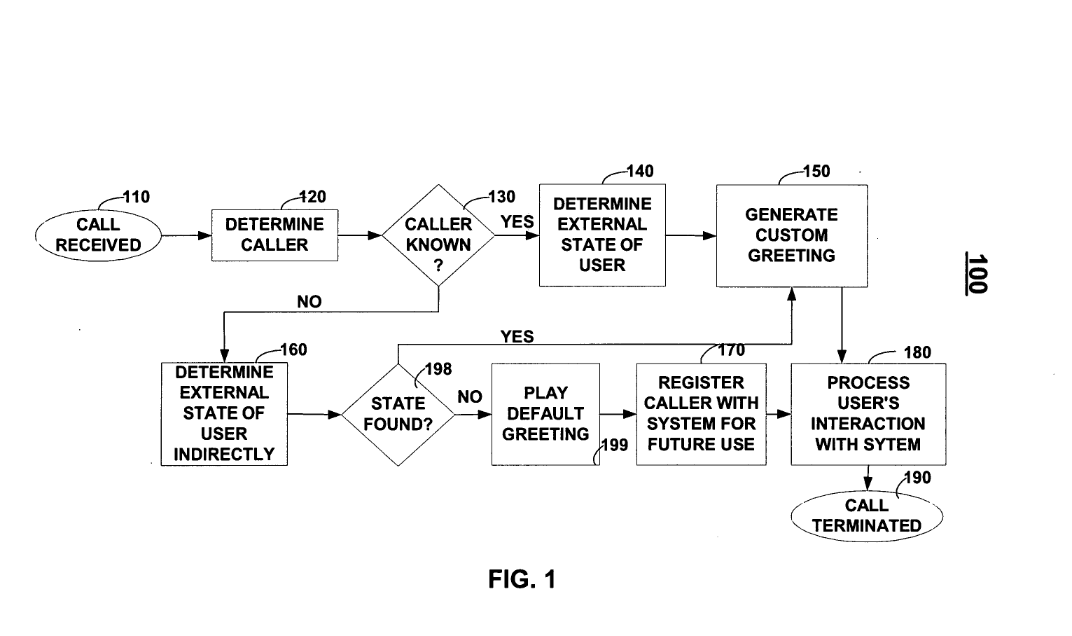

FIG. 1 shows flow chart 100 that includes a number of steps that can be included in a predictive automated response process. The process of flow chart 100 begins when a call is received at step 110. Next, the identity of the caller is determined at step 120.

A caller can be identified in a number of ways. For example, an incoming call signal may include the phone number of the caller before the voice data is transmitted. As such, the identify of the caller can be determined based on the caller's phone number. Particularly, the phone number can be compared against a list of the customer phone numbers. If a match is found, then the system operating process 100 can be configured to assume that the caller is the customer associated with the matched phone number. Persons skilled in the art will appreciate that a system implementing process 100 can utilize third party information to indirectly determine the identity of a user. For example, process 100 can include a step of performing a reverse phone number search to determine the name of the entity to which the number is registered. In this manner, a step can be included in process 100 that compares the entities name found by the search to a list of customer names stored on, for example, a database. As such, a caller can be identified if, for example, that caller is calling with a wireless telephone number when only the caller's home phone number is on record.

Step 130 determines whether or not the identity of a caller has been determined (e.g., by matching telephone numbers or matching the caller name with the customer name). If the identity of the caller is known, then step 140 may be performed in which the external state of the user is determined. If the identity of the caller is not known then the state of the user's external state may be attempted to be indirectly determined based on information associated to the caller's phone number that is not associated to a customer's account.

Persons skilled in the art will appreciate that the identity of the actual person making the call is not determined by step 130. Rather, the most likely origin of the call is determined. Process 100 can be configured such that no confidential information is distributed unless the identity of the specific caller is confirmed. For example, a user may be asked “are we speaking to Susan Pracht, press 1 for YES; 2 for NO” by process 100. Process 100 may then prompt the user to enter a Private Identification Number (PIN) if a PIN is associated with the identified account. In this manner, private information can be kept confidential unless the specific identity of the caller is determined. As such, customer account information may be defined as being private or public (e.g., via Meta Tags). This way, a sister using her brother's wireless telephone to pay her telephone bill because her phone has been deactivated for non-payment is not provided confidential information about her brother.

In step 140, the external state of the caller is determined. The possible external states of a caller may vary from implementation to implementation. For example, one external state for an internet provider may be “service disrupted.” As per another example, one external state for an online retail store may be “the three-day shipment of your Nintendo Revolution will arrive on Tuesday because Monday is Memorial Day.” Such external states can be manually defined through an administrative system or interface (e.g., a graphical user interface) either remotely through the internet or directly through an input to the system. Accordingly, an administrator can create and associate audio messages to each external state. Such audio messages can be dynamic in that certain words change from user to user. Accordingly, a text-to-voice audio system (e.g., a voice synthesizer) may be employed in the automated response system or embodied as software. As such, non-audio data (e.g., text) may be transferred through a communications channel in higher densities then if audio was transferred. The administrative system can also allow an administrator to change the characteristics of a particular state such that the state is triggered for a different set of callers.

To determine the external state of a caller, numerous types of information may be utilized by process 100. For example, the caller's personal information (e.g., age, sex, address, order information, telephone number, third party information about a user's person), environmental information, or even information about the time of day may be utilized to define a state and associate a user to that state. Using a state in which time can be a factor, a cable company can define a state in an predictive response system such that if a user calls during the time that a cable repair man is supposed to visit that day, the system can note the expected arrival time. Furthering this example, the predictive state can be defined as a late repairman and the message associated to the predictive state can take the form “hello Jeff, we see that it is 4 pm and you were supposed to have a repairman come at 3 pm, our records indicate that the repairman is 15 miles away from you on interstate 95 and you are the next job on his list.” As was discussed above, messages can be dynamic such that information can be added to a message for any particular caller in any particular situation. For example, a caller's name may be utilized to add content to a dynamic message.

The search for a state (or an event) may occur in a variety of ways. For example, a series of iterative loops can be implemented in software. Each loop can take a different piece of user information and search the available states/events to determine if that piece of information is a characteristic of a state/event. If so, the remaining characteristics of the state/event can be compared against user information. Alternatively, the characteristics of the states can be checked, one by one, against a particular user's information.

Persons skilled in the art will appreciate that a number of states/events may exist for a particular caller. Thus, the system can be configured to provide only the most relevant to a caller, provide them in a random order, or provide them in order of popularity or importance. As such, a popularity and/or level of importance field can be associated to each state/event. For example, an administrator may, via an administrative system or input to process 100, associate a larger importance to an environmental event then as to a billing event. Extending this example, an administrator may associate a higher importance (e.g., a percentage or number) to a state for “loss of service due to a storm” then to a state for “your balance is 12 days overdue.” Either an importance or popularity rating can be determined autonomously. For example, if certain percentage of a number of recent visitors (e.g., visitors in the last hour) request a particular option (e.g., report a problem with your internet connection) then a predictive message may be autonomously generated based on the menu option and given a large level of importance/popularity. Such a predictive message can take the form “it appears that our internet service is down in the state of Georgia.”

If an external state of a user is determined in step 140, then step 150 can be utilized to generate a custom greeting for that caller. As mentioned above, custom greetings can be generated autonomously or entered manually by an administrator and associated to one or more states/events. As a result of process 100, the caller's reason for calling is predicted without the user manually entering in any type of information. Accordingly, process 100 provides to the user either an answer to a predicted question or a shortcut to the most likely menu option desired by the caller.

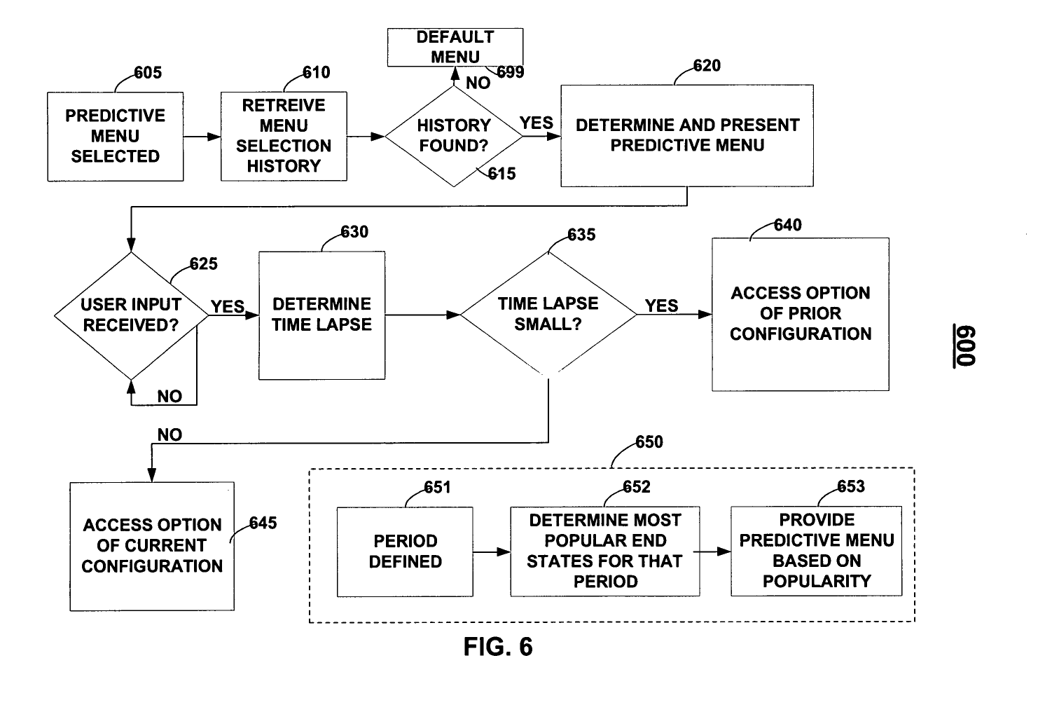

Persons skilled in the art will appreciate that the predictive system may not answer the caller's question as a result of generating custom message 150 and providing it (e.g., transmitting it) to a caller. As such, the caller can be prompted with a message inquiring as to whether or not the caller needs assistance with anything else. If the caller still needs assistance, then an automated menu can be presented to the caller. This automated menu can also be predictive such that the menu options and/or the order of the menu options change based on user information and/or other information (e.g., popularity information). One predictive menu process is discussed further below in connection with flow chart 600 of FIG. 6.

If the caller is not identified directly in step 130, the external state of the user may still be determined. More particularly, a probable reason why a person having a particular phone number is calling can be determined and associated to a state/event. For example, the geographical area of a caller can be determined based on the area code of the incoming telephone number. Similarly, process 100 can use third party information to determine if the number is a landline or a wireless line. Accordingly, process 100 can determine that the call is originating from the telephone number's area code if the call is emanating from a landline. Thus, process 100 can determine if any events/states are associated to that geographical area. Step 198 can determine if a state/event is associated to the incoming number and, accordingly, can generate a message for this state/event in step 150.

Otherwise, a default greeting can be played to a caller at step 199. Persons skilled in the art will appreciate that phone number can be blocked such that a receiving entity does not know the phone number of the calling entity. As such, a default greeting can request identification information from a caller. For example, a default greeting can ask a caller to say the customer's name or enter in an account number or a telephone number. For audio input, process 100 can include a voice-to-text converter. If information is entered, process 100 can then check this information to either directly or indirectly identify a user. A default greeting can take many forms and could just be the presentation of an options menu to a caller.

At any point in process 100, information may be written to a portion of an implementing system (e.g., a remote database or web server). For example, every user interaction with the system can be saved and associated to the caller such that the predictive response system can become more predictive for a particular user. Accordingly, process 100 can create a profile for an unregistered caller by registering the number and associating data (e.g., what options the user chooses from an options menu) for future use in the predictive response system. Such a registration process can be static and require no user interaction or the user can be requested to enter in additional information (e.g., enter via touch-tone phone input or verbal input) such as name, address, sex, other telephone numbers, and age. Such a step can be embodied in step 170. After the registration process is complete, step 180 may be initiated and the system can present an options menu or other data or services to the caller. Process 100 completes when the call is terminated in step 190.

Persons skilled in the art will appreciate that the predictive nature of process 100 can decrease the average time that a caller is, for example, connected to a customer service line. If the average time is low enough, process 100 can route a caller's call to a customer service representative if the one or more predictive messages do not answer a consumers question. As a result, the delivery of an options menu to a caller can be removed from process 100.

Persons skilled in the art will appreciate that a dynamic predictive message can be utilized in process 100 at any time. For example, dynamic predictive messages can be generated at any message option. As such, a Canadian user could be provided an initial predictive message that all Canadian internet products are unavailable for the day, but when the billing option is selected the user can be provided with a predictive message associated to billing. In this manner, data fields (e.g., Meta Tags) can be associated to each predictive message that describes one or more categories (e.g., menu options) that the message is associated with. Utilizing a category field as well as a popularity/importance field, the predictive message most likely to answer the user's question for a particular option can be predicatively determined and played to a caller. Expanding on the previous example, a predictive message for a billing option could take the form “our last bill was returned because you no longer live at the address on file, please update your address.”

Persons skilled in the art will appreciate that process 100 of FIG. 1 can advantageously be employed in a variety of systems.

As in one example, process 100 can be employed by an internet service provider. The system can be configured to know the general status of a user at the individual level. Such a general status could be, for example, the status of the user's internet connection (e.g. awaiting installation, connection down, connection working properly). Thus, if the system autonomously determines that the user's internet connection is down, a predictive message may take the form of “we see that your connection is down, the problem should be resolved in the next 90 minutes as repair personnel have been dispatched to fix a broken line.” Thus generally, knowledge of the in-process events associated with delivery a service or product to a user can be stored in a database (or memory) and associated to that user.

As in another example, one of the activities for a wireless internet service provider is to conduct a “site survey” to determine if the requested service is in a coverage area with sufficient signal strength. If a customer calls, the status of the site survey service can be retrieved (e.g., complete or incomplete) and utilized to deliver a predictive message or determine the external state of the user.

Persons skilled in the art will appreciate that a predictive response system can request information on a user from a variety of devices. Such requests can take many forms. For example, the predictive response system can send a message to a product associated with the customer's account. In this manner, if a caller has purchased internet service from company then the software that runs the internet service can be sent a message. A non-response after a period of time can be utilized to determine the state of the product (e.g., that the internet connection is down). Put another way, a product can be pinged for information. Similarly, information can be requested from sources such as repairmen and third parties. Using repairmen as an example, the repairmen can be provided with a Global Positioning System (GPS) receiver and these GPS receivers can be employed to transmit information to a response system on the repairmen's position when a request is made for this information. As per another example, the status of a package can be requested from a third party mail service (e.g., Fedex or the United States Postal Service).

Persons skilled in the art will appreciate that information retrieved by, or accessible to, a predictive response system can be transmitted to a customer service representative when a call is routed to that customer service representative. Such information can be presented to a caller via a Graphical User Interface (GUI). As such, the predictive messages already provided to a caller may be grouped together and displayed on the GUI. Additionally, the predictive messages that could also be generated (or that were generated but never sent to the user) can be grouped together and displayed on the GUI. Similarly, events/states that are applicable to a user can be displayed on the GUI. With the advent of such a functionality, the time that a caller interacts with a customer service representative can be decreased.

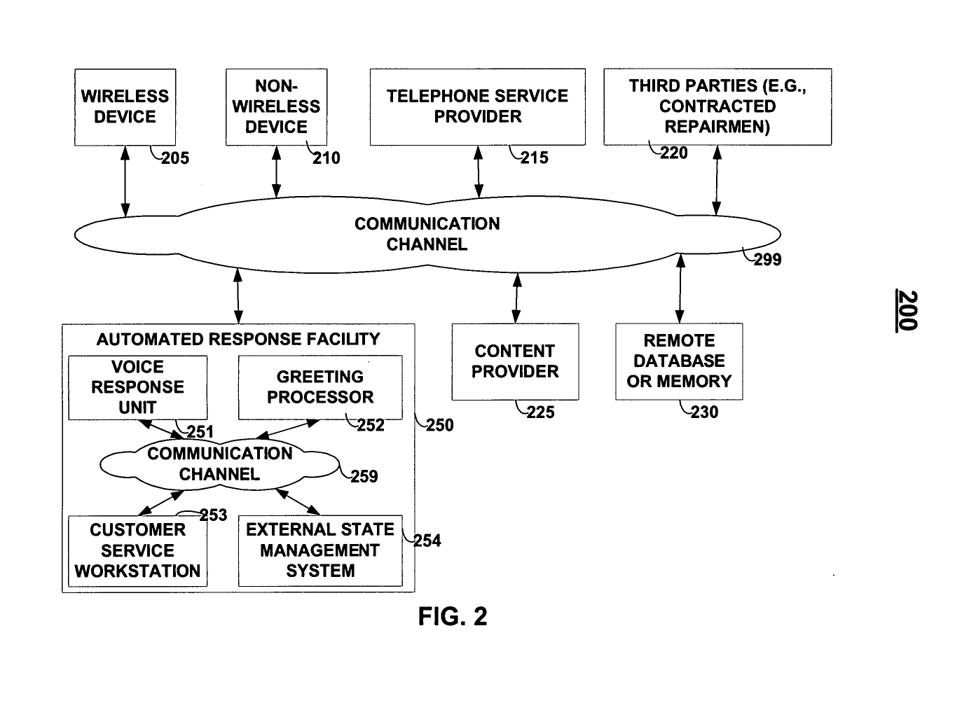

FIG. 2 shows network topology 200 that includes automated response facility 250 that can be contacted through communication channel 299. Communications channel 299 may be, for example, a wireless network, land-based network, an intranet, or the internet (e.g., a voice over internet service can be provided as a predictive automated response system).

Automated response facility 250 can include communications channel 259 that can be the communications channel coupling voice response unit 251, greeting processor 252, customer service workstation 253, and external state management system 254 (e.g., an administrative system). Generally, voice response unit 251 acts as the intermediary between a customer and the information stored in retrievable by response facility 250. Greeting process 252 may be utilized to determine the initial greeting and send the initial greeting (e.g., a predictive initial greeting) to voice response unit 251. External management system 254 may be utilized to define the characteristics of a state/event that triggers a particular greeting (e.g., internet service is down). Customer service workstation 253 can include a GUI that allows a customer service representative to access (e.g., READ and WRITE) information located in automated response facility 250 or any other system of network 200.

Content providers 225 can be included in network 200. Accordingly, third party content providers 225 can be accessed by the various systems of automated response facility 250. Similarly, automated response facility 250 can provide information to content providers 225. Persons skilled in the art will appreciate that in order to decrease the time needed to generate a predictive message, automated response facility can periodically update customer information from content provider 225. For example, automated response facility 250 may continually go through its customer database and update information from content providers 225. For example, content provider 225 may be a credit history reporting service. As such, the credit history can be updated daily for each customer such that if a customer requests a line of credit from the service associated to response facility 250, content providers 225 do not have to be contacted to provide a predictive message (or other information/options) to that customer. One example of a content provider 225 may be a telephone service provider 215. Persons skilled in the art will appreciate that the company utilizing automated response facility 250 can be included in network 200 For example, telephone service provider 215 can have its own automated response facility 250 or share a facility with another company). If multiple companies share the same automated response facility 250, then part of the predictive process (e.g., process 100) may be to predict what company the caller is trying to communicate with (or obtain information from).

Similarly, automated response facility 250 can communicate with third parties 220 and can periodically, or continually, update information associated to a caller by obtaining information from third parties 220. Such updating can be dependent on an event. For example, suppose a repairman is supposed to visit a customer during a period of time, then automated response facility can request the location of such a repairman periodically during this time (or throughout the day).

Remote database or memory 230 may be included in network 200 and act as a repository for storing client account information. By including a remote database 230, multiple automated response facilities 250 can be provided with easy access to (e.g., can READ and WRITE) the same customer information.

Persons skilled in the art will appreciate that a client can contact automated response facility 250 in a variety of ways. As discussed above, a client can contact facility 250 by way of a wireless telephone (e.g., wireless device 205) or a non-wireless, land-based, telephone (e.g., non-wireless device 210). Clients can also contact facility 250 through, for example, a voice-over-internet program. A telephone number may be associated to such a voice-over-internet service such that facility 250 can identify a user based on this telephone number. Alternatively, such a service may provide the user's Internet Protocol (IP) address through a Transmission Control Internet Protocol (TCIP). As such the caller's IP address may be utilized for identification purposes. In this manner, a caller does not have to contact response facility 250 utilizing voice data as medium for data exchange. Instead, a caller can provide requests to a response system via questions entered as text into a webpage. Such text can then be sent via the internet to the response system. The response system can reply by providing the webpage an HTML page that was generated with a predictive HTML generation program.

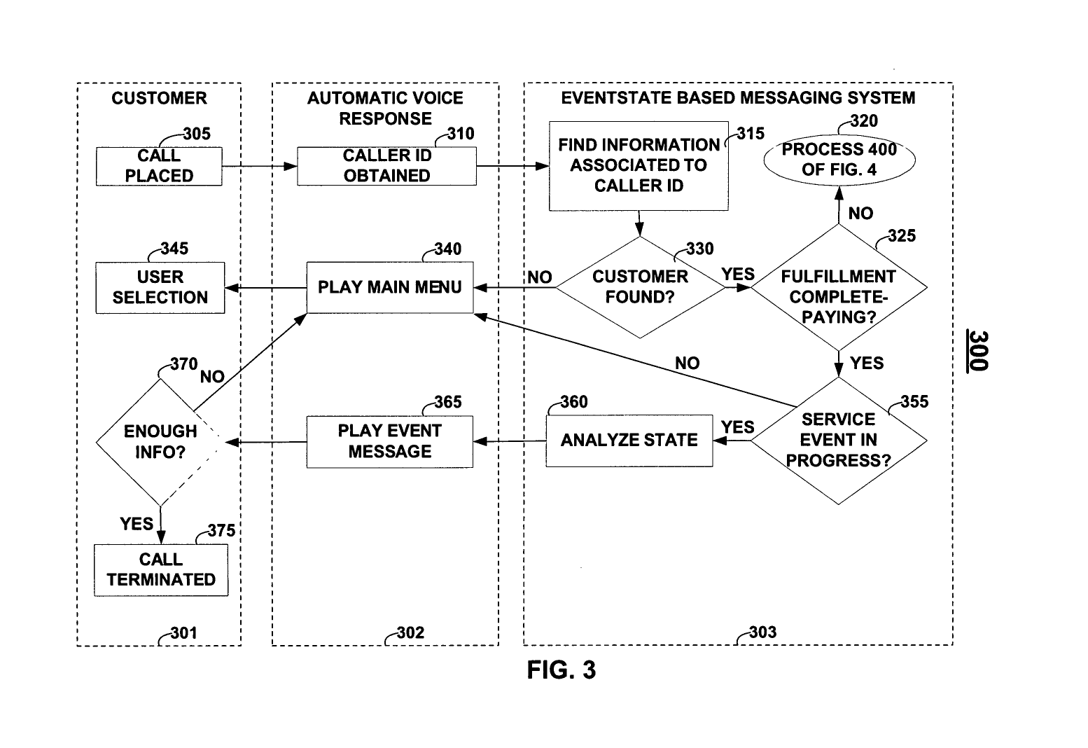

FIG. 3 shows process 300 that generally includes three portions, customer interaction steps 301, automated voice response delivery 302, and event/state based messaging steps 303. Steps 302 and 303 may be employed as one system or different systems.

Step 305 initiates when a call is placed. The telephone number of the caller is then obtained in step 310. Step 315 searches customer information to determine if any information is associated to the caller's telephone number. Such information may be, for example, an account number associated to the caller's telephone number. A customer's identification may be, for example, the caller's phone number itself or an account number associated to the caller's phone number. If a customer identification is not found in step 330 then a default main menu may be played to a user in step 340. Accordingly, a user can use a touch tone phone, or any input device, to interact with main menu 340.

If a customer is found, the type of customer can be determined at step 325. Particularly, the relationship of a customer to the entity employing process 300 can fall into numerous categories. For example, a customer may be a returning guest (e.g., a potential customer), a customer with a past order history (e.g., a past client), or a customer that currently is subscribed to a product-service (e.g., a client). In this manner, persons skilled in the art will appreciate that a customer can be identified even if the customer has never set up an account. For example, a user may be autonomously registered with the response system if the user is a new user. In this manner, the user's interactions with the main menu can be saved as well as other information (e.g., time of day of the call, duration of the call, geographic area of telephone number).

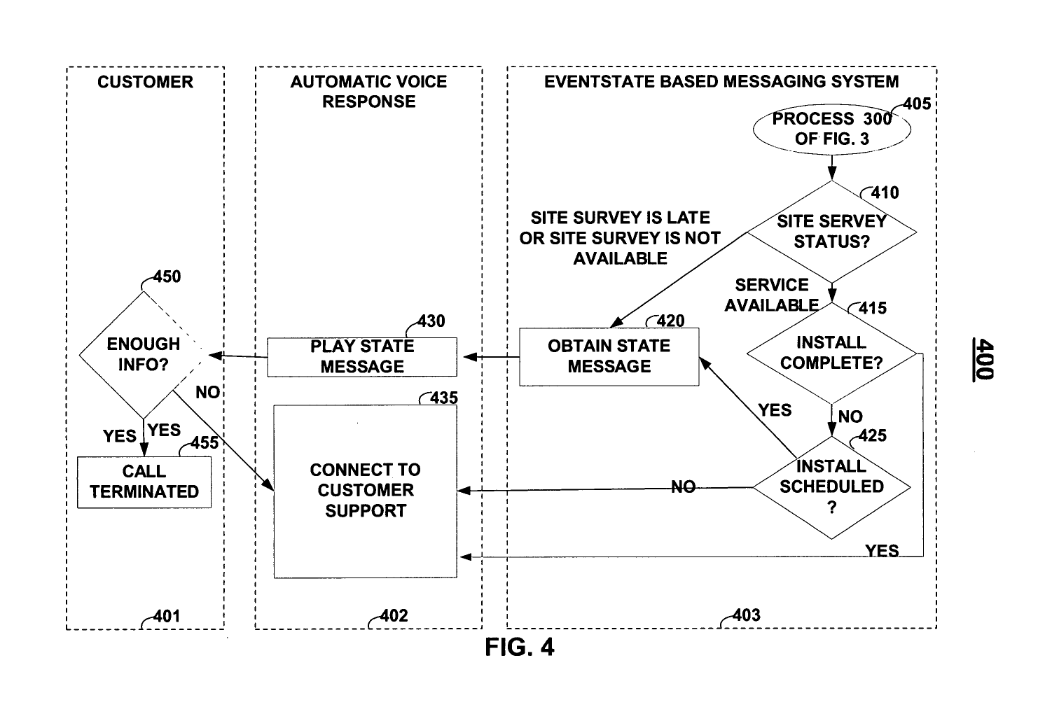

A user's type may be associated to a variety of things. As shown in step 325, process 300 can determine if the customer is a paying customer and whether fulfillment of an obligation owed to the customer is complete. If an obligation is owed, step 320 can be initiated, which is discussed below in further detail in connection with process 400 of FIG. 4.

An event/state-based messaging system can use any information stored for a caller (e.g., stored with the customer identification) to provide predictive event/state-based messaging. Such an event/state-based messaging system can be utilized in a variety of ways. For example, conditions that define an event/state may be compared against the information associated to the identified caller to determine (e.g., predict) whether or not there is a likely reason for the call. If a likely reason is determined, then a message associated to the event can be delivered to the user (e.g., tailored to the caller and delivered to the user).

Accordingly, step 355 may be initiated if the fulfillment of an obligation to a user is not complete or a paying problem exists as may have been determined in step 325. As stated above, importance and/or popularity information may be utilized to determine either the order the conditions of the events/states are checked against user information or the order matching events/states are processed (e.g., provided to the caler). After a state/event is determined to be applicable to a caller (e.g., by matching the events/state's conditions against the user's information), the state/event can be analyzed. Persons skilled in the art will appreciate that event/state based messaging can cause a system to perform numerous autonomous functions in addition to sending a predictive message to a caller. For example, an event/state associated to billing may, for example, cause the credit history of the user to be obtained while the caller's predictive message is being generated. As per another example, if the caller was determined to have used a fraudulent credit card number in the past, the system can contact the authorities and provide the authorities with the customer's telephone number while a predictive message is being generated. As such, analysis step 360 generally determines the actions that the system implementing process 300 is to take now that one or more events/states are applicable to the caller.

Any actions that were determined to be executed in step 360 can be executed in step 365. Such actions can include, for example, playing a predictive message associated to the event/state. The caller can then be prompted to see if the supplied information answered all of the user's questions in step 370. If the user still have remaining questions, step 340 can proceed and play the main menu to the caller. Else, the call can be terminated at step 375.

Turning next to process 400 of FIG. 4, a continuation of the process of process 300 of FIG. 3 is provided. Particularly, step 403 continues from step 320 of FIG. 3. Similar to process 300 of FIG. 3, the process 400, includes three portions—customer interaction steps 301, automated voice response delivery 302.

Persons skilled in the art will appreciate that one of the provisions of a wireless internet service is the ability to conduct a “site survey” to determine if the requested service is in a coverage area with sufficient signal strength. Accordingly, process 400 is one embodiment of a process that can be employed on, for example, a predictive automated voice response system for a wireless internet service provider. In this manner, step 410 may determine the status of the site survey. The status of an event can be more complex than a simple YES or NO (e.g., a logical ‘1’ or ‘0’). As could be the case with step 410, service status can take three states. For example, a query into the status of a site survey could return that service is available (as a result of the survey being completed), the site survey is late, or the site survey is not available for a particular area. Additional, a survey status can be that the service is not available (as a result of a survey being completed).

If the site survey is late (e.g., has not occurred yet) or the site survey is not available in for the customer (or service is not available as a result of a negative site survey), then the message for that event/state may be retrieved in step 420. If the message is dynamic, the variables needed by the dynamic message may also be retrieved (e.g., the caller's name and geographic location). Such a message could take the final form of “Mr. Pracht, we are sorry to inform you that your site survey of your residence in Pittsburgh is delayed until February 7.” Here, the dynamic variables would be the customer's name (which retrieved Mr. Pracht for this caller), the customer's geographic location for the survey (which retrieved Pittsburgh for this caller), and the date of completion of the site survey associated to the caller (which retrieved February 7 for this caller). Once the variables are found they may be converted into text and asserted into a template message for the caller's event/state. Then a text-to-voice synthesizer can be utilized to deliver the message to a user over, for example, a traditional telephone line in step 430. If the caller is satisfied with the message in step 450, then the call can be terminated in step 455. Else, either a generic default message can be played, a main menu, a dynamic menu, or the caller may be connected to customer support in step 435.

If service is available, then step 415 may be triggered. Persons skilled in the art will appreciate that events/states may lead to the comparison of conditions of specific events/states if the conditions of an event/state are met. For example, if service is determine to be available, the predictive system may determine whether or not the service has been installed (a specific state). In this manner, if the conditions of an event/state are met, a predictive does not have to be played. Instead, an action can be performed. Such an action can be comparing the information of a user against the conditions of a specific state/event.

If the installation is determined to be complete at step 415 then the caller can be routed to a customer service representative at step 435.

A customer service representative can be provided with administrative/management tools to the system. Additionally, a customer service representative may be presented with the information that the predictive system has already determined for the caller. For example, the predictive system can tell the customer service representative where the predictive system left off such that the customer service's first statement is a predictive message (“e.g., it seems like your installation was completed on October 12”).

If the installation is determined to not have been completed in step 415, then step 425 can determine if the installation has been scheduled. If the installation is scheduled, then a predictive message can be generated based on the information associated to the scheduling. Else, the customer can be routed to customer support in step 435 (as well as the information obtained by the predictive process).

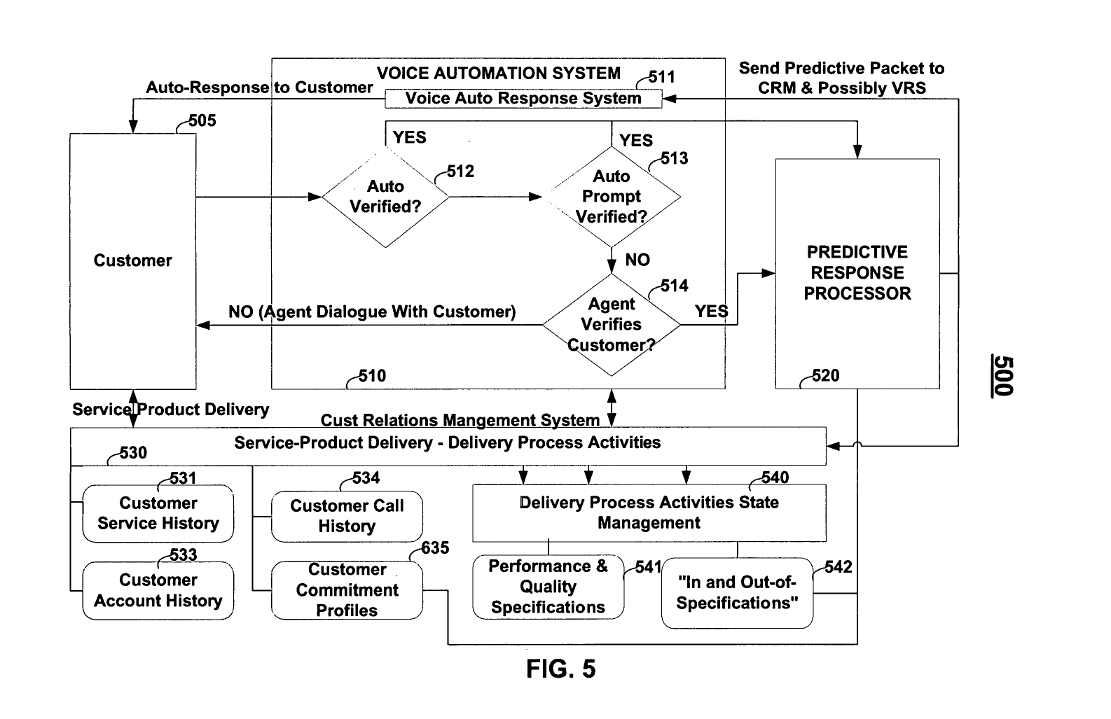

Turning to FIG. 5, one predictive automated response system is shown that includes a voice automation system 510 coupled to (i.e., in communication with) predictive response circuitry 520. Predictive response circuitry 520 may be, for example, embodied in a processor or employed as software in memory. Customer relations management system 530 may also be included in system 500 and coupled to (i.e., in communication with) voice automation system 511 and/or predictive response processor 520. Persons skilled in the art will appreciate that customer 505 may be able to interact with any component of system 500 including, for example, management system 530, voice automated system 511, or predictive response processor 520.

One process flow that may be associated to system 500 occurs as follows. A caller calls voice automation system 510, which attempts to autonomously determine the identity of the caller. If the identity of the caller is determined, then predictive response processor may be forwarded information about the caller. Else, the caller may be prompted to manually enter information that is representative of the caller's identity (e.g., the user's telephone number if the telephone number is blocked). If the user enters information that voice automation system 510 uses to successfully determine an identity then this information is routed to processor 520. Else, an agent may initiate a conversation with a caller in step 514 or may review the information to determine the identity of the caller. Once the identity of the caller is obtained, predictive response processor 520 is provided with this information. Persons skilled in the art will appreciate that any process step may be performed by either voice automation system 510, predictive processor 520, or management system 530.

Predictive response processor can use the identity information of a caller to determine the caller's most likely reason for calling. In this manner, processor 520 can scan the caller's information in order to determine if there are any problems, or recent activity, in the caller's account and assume that the caller is calling to solve these problems or inquire about the recent activity. For example, system 500 may be utilized by a credit card company. If a client traditionally only purchases items having small values in the continental United States but the credit card was maxed out from a single foreign transaction within a particular time before the call (e.g., 1 day), then process 520 can spot this as the most likely reason the caller is calling.

Information gathered about the caller can be bundled together with information remotely obtained from processor 520 (e.g., from third party information suppliers) or determined by processor 520 (e.g., a list, in order of importance, of the most likely reasons a caller is calling). Such information may then be utilized by predictive response processor 420 to, for example, generate a predictive message (e.g., a predictive initial greeting) or may be distributed as a packet to voice automation system 511 or customer relations management system 530 for further processing or analysis. In this manner, a customer support representative may be provided with a GUI that contains a list of the most likely reasons a caller is calling such that the customer support representative can minimize the time spent talking to any one client. In such a GUI, each reason could be a hyperlink to information regarding the event/state. In this manner, a customer service representative is provided with a guide to help analyze the data contained in a predictive packet.

Any component of system 500, such as processor 520, management system 530, or voice automation response system 511, or voice automation system 511 may be operable to utilize customer service history 531, customer account history 533, customer call history 534, and/or customer commitment profiles 635. Histories 531-533 may be, for example, profiles that are stored in databases such that information may be READ from, and WRITTEN into, the databases in an organized manner. Any number of databases, profiles (or other data structures) may be utilized to store information about a user. Some of these databases may be located locally in system 500 or remotely (e.g., with a third party information provider). Any type of information may be used in system 500 to aid, for example, the predictive process. For example, customer status information (e.g., new, waiting for site survey, waiting for installation, installed user, and non user), site survey status (e.g., undefined, scheduled, successful, unsuccessful), network status (e.g., undefined, working, not working, partially working), time since last call, duration of last call, number of prior calls, time since last change in network status, and billing status are just a few types of information that may be utilized by system 500. System 500 can be modified for implementation in numerous industries. For example, a package delivery service can implement system 500, for example, to provide predictive messages associated to recently sent packages (e.g., estimated delivery or arrival time). A product vendor can implement system 500, for example, to provide predictive messages based on whether a product that has been inquired about in the past has shipped or arrived yet in inventory. A real estate broker can implement system 500, for example, to provide predictive messages based on whether new real estate has gone on sale that day for the area associated to a caller's profile (e.g., areas the caller wants to purchase property) or telephone number. Credit card companies can implement system 500, for example, to provide predictive messages based on whether fraudulent activity has occurred recently on your card or your credit card has expired.

Customer commitment profiles 635 may also be included in system 500 to define a set of service-product quality dimensions such that when met the customer may have a high satisfaction level with the service-product. Such a profile may be associate to a particular product/service, customer, or group of customers. A customer service representative can then be proactive in managing customer satisfaction distracters. Such a commitment profile can include information such as, for example, guaranties and warranties formally committed to the customer and internal service-product goals that, when met, are known to increase customer satisfaction, extend customer life, and increase customer adoption of new products. As per a particular example, profile may include in 635 information for a Samsung A800 that all phones have a 1-year warranty and to phrase negative information about the warranty to a caller as “we are sorry, but the warranty ran out on December 1st,” instead of “the warranty doesn't apply to your situation.”

Data 541 and 542 may be included to provide a place to receive and store information related to, for example, a product or service. Quality specifications 541 may include technical specifications for a product/service as well as how a product/service operates in a certain situation. In and out of specifications 542 may act as a repository for data associated to performance and quality specifications introduced by the customer or other customers. For example, specification 542 may be the location of the list of problems that the customer has faced before with the particular product and/or service under discussion.

FIG. 6 shows process 600 for providing a predictive menu to a user (e.g., tailoring the configuration of, or presentation of, a menu options tree). Step 605 may occur, for example, if a predictive message is not determined by a predictive processor for a given caller. Thus, the caller may be provided with either an options menu, or call tree, or a default greeting. Process 500 provides a dynamic options menu, or call tree, that is modified from the default options menu based on user information (e.g., information associated to a user's account and/or the user's interaction with the menu). For example, the customer's selection history may be obtained in step 610. If a history is not found, then the default menu may be played at step 699 and a selection/interaction history profile may be created to store the user's future selections. If a selection history is found, then step 620 may utilize this history to determine the order that menu options are presented to a user based on, for example, user information, activity from other customers having the same locality, the recent global activity of options, as well as the user's selection of history. The caller is then presented with the menu.

Step 625 determines when the caller makes a selection (e.g., sends input). When an input is made, step 630 determines the time lapse of the input. A time lapse may be determined, for example, by determining the amount of time that the caller waited between initiating the call and providing an input (or from when predictive menu started to play to when an input was provided). If the time lapse is small, it suggests that the caller is aware of a organization of the menu from a prior visit and is entering in input according to that recollection. As such step 640 may look at the selection history of the user to determine what string of selections correlates to the caller's initial input (e.g., the most popular string having the same initial input). The menu may then be presented the same way the menu was provided to the caller in the previous instance. For example, the input entered in by the user may trigger the selection associated to this input on the prior configuration—not the current configuration. Alternatively, a predictive message may be provided representative of the end state of the previous string of selections or a hyperlink to the end option. Persons skilled in the art will appreciate that a small time lapse may be, for example, the time it takes the first word of the menu to be provided to the caller. If the time lapse is not small (suggestive the caller listened to the menu), then the predictive menu is assumed to have played until the desired option was heard and selected. Thus, the option correlating to the caller input for the current configuration may be accessed in step 650.

Process 650 may be utilized to configure a predictive menu. Particularly, a period of time may be defined for a system in step 651. Step 652 may then prioritize all end options available in an options menu based on the amount of activity the end options have received over the period defined in step 651. As a result, a menu based on recent popularity may be provided to the user in step 653.

Persons skilled in the art will appreciate that the term caller is synonymous with the term user, customer, client, person, or entity. As such, a person with a customer account does not need to have ever placed a call to have the information associated with that account utilized by an automated response system. Accordingly, information related to a customer account in which a person has never placed a call may be, for example, indicative that the person is not experiencing problems. Such information can be utilized by the automated response system to produce a predictive message or predictive menu option. Similarly, a caller can communicate with the automated response system in a variety of ways and through a variety of mediums other than with a telephone. Utilizing an example from the discussion above, a user can contact the automated response system by submitting data through the internet. In turn, the automated response system can transmit a predictive message in the form of HTML code before, for example, the user is provided with an opportunity to submit additional data.

From the foregoing description, persons skilled in the art will recognize that this invention generally provides intelligent automated responses to a user's call before the user provides any information to the automated response system. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

What is claimed is:

1. A method comprising:
receiving an incoming telephone call;
determining whether there is a most likely reason for said telephone call;
generating a predictive message based on said most likely reason when said most likely reason is determined; and
transmitting said predictive message to said caller prior to accepting inputs from said caller.

2. The method of claim 1, further comprising identifying the telephone number that placed said incoming telephone call.

3. The method of claim 2, further comprising:
searching for a customer account associated with said telephone number.

4. The method of claim 3, further comprising finding said customer account, wherein said determining said most likely reason for said telephone call comprises recognizing problems with said customer account.

5. The method of claim 4, wherein said determining said most likely reason for said telephone call comprises ranking said recognized problems with said customer account in order of importance.

6. The method of claim 5, wherein said most likely reason for calling is the most important of said recognized problems.

7. The method of claim 2, further comprising determining a geographic location associated with said telephone number.

8. The method of claim 7, wherein said determining said most likely reason for calling comprises recognizing a problem in said geographic location.

9. The method of claim 2, further comprising determining whether or not said telephone number is associated with a wireless telephone.

10. The method of claim 9, further comprising determining the service provider of said wireless telephone.

11. The method of claim 1, wherein said determining said most likely reason for said telephone call comprises recognizing the most popular reason for calling for a period of time.

12. The method of claim 1, wherein said determining said most likely reason for said telephone call comprises recognizing the most popular reason for calling for the day that said incoming call was received.

13. The method of claim 1, wherein said determining said most likely reason for said telephone call comprises recognizing the most popular reason for calling for the day of the week that said incoming call was received.

14. The method of claim 11, wherein said recognizing the most popular reason for calling for said period of time comprises ranking the most popular menu items from a plurality of menu items that were presented to past customers.

15. The method of claim 1, wherein said determining said most likely reason for said telephone call comprises recognizing the most popular reason for calling.

16. The method of claim 1, wherein said determining said most likely reason for calling comprises the most popular reason for calling for a period of time for a particular geographic location.

17. The method of claim 1, wherein said determining said most likely reason for calling comprises recognizing the most important predictive message, wherein said predictive message is said most important predictive message.

18. The method of claim 1, wherein said predictive message is a dynamic predictive message.

19. The method of claim 18, further comprising:
identifying the telephone number of said incoming telephone call;
identifying a user account associated with said telephone number;
identifying a user name from said user account;
adding a form of said user name to said predictive message.

20. The method of claim 18, further comprising:
identifying the telephone number of said incoming telephone call;
identifying a user account associated with said telephone number;
identifying a geographic area associated to said user account;
adding a form of said geographic area to said predictive message.

21. The method of claim 1, further comprising recognizing that the telephone number of said incoming telephone call is a blocked number.

22. The method of claim 21, wherein said determining said most likely reason for calling comprises either determining at least one reason for calling associated with the most popular reasons for calling or determining the most important predictive message from a list of predictive messages.

23. The method of claim 1, further comprising providing an inquiry message to determine if any additional information is needed after said predictive message has been transmitted.

24. The method of claim 23, further comprising receiving data in said telephone call.

25. The method of claim 24, further comprising providing a predictive message representative of a second most likely reason for said telephone call.

26. The method of claim 24, further comprising providing predictive menu options in said telephone call.

27. The method of claim 1, further comprising:
determining the telephone number of said incoming telephone call;
identifying a customer account associated to said incoming telephone call, wherein said predictive message is based on prior activity in said customer account.

28. The method of claim 1, further comprising:
determining the telephone number of said incoming call, wherein said predictive message is based on a prior selection history associated to said telephone number.

29. The method of claim 1, further comprising providing an inquiry message to determine if any additional information is needed to be provided after said predictive message has been transmitted.

30. The method of claim 29, further comprising receiving data representative of the need for additional information.

31. The method of claim 30, further comprising routing said telephone call to a customer service representative after said data representative of the need for additional data is received.

32. A method comprising:
storing a delivery status of a service for a customer in an event history associated to said customer;
receiving a telephone call;
identifying the telephone number of said telephone call as the telephone number of said customer;
retrieving said delivery status from said event history; and
providing a voice message to said customer representative of said delivery status without requiring said user to enter in any data in said telephone call.

33. A method comprising:
storing an installation status of a service for a customer in an event history associated to said customer;
receiving a telephone call;
identifying the telephone number of said telephone call as the telephone number of said customer;
retrieving said delivery status from said event history; and
providing a voice message to said customer representative of said installation status without requiring said user to enter in any data in said telephone call.

34. A method comprising:
storing a shipment status of a product for a customer in an event history associated to said customer;
receiving a telephone call;
identifying the telephone number of said telephone call as the telephone number of said customer;
retrieving said delivery status from said event history; and
providing a voice message to said customer representative of said shipment status without requiring said user to enter in any data in said telephone call.

35. A method comprising:
storing a survey status of a service for a customer in an event history associated to said customer;
receiving a telephone call;
identifying the telephone number of said telephone call as the telephone number of said customer;
retrieving said delivery status from said event history; and
providing a voice message to said customer representative of said survey status without requiring said user to enter in any data in said telephone call.

36. A system comprising:
a receiver for receiving an incoming telephone call;
a memory for storing customer account data; and
a processor for providing an predictive automated voice response feature for identifying the telephone number of said incoming telephone call, locating customer account data associated with said identified telephone number, and providing a predictive message in said telephone call associated to said customer account data without requiring data to be input in said incoming call.

37. The system of claim 36, wherein said predictive message is generated by synthesizing text data into audible signals.

38. The system of claim 36, wherein said predictive message is stored in said memory as audio and retrieved from said memory when said predictive message is provided in said telephone call.

39. A system comprising:
a receiver for receiving an incoming telephone call;
a memory for storing customer account data; and
a processor for providing an predictive menu options feature for identifying the telephone number of said incoming telephone call, locating customer account data associated with said identified telephone number, and providing at least one predictive menu options in said telephone call associated to said customer account data without requiring data to be input in said incoming call.

40. A system comprising:
a receiver for receiving an incoming telephone call;
a memory for storing caller activity; and
a processor for providing an predictive menu options feature for providing at least one predictive menu option in said telephone call associated to said caller activity a without requiring data to be input in said incoming call.

41. A system comprising:
a receiver for receiving an incoming telephone call;
a processor for providing menu options in said incoming telephone call; and
a memory for storing the popularity of said menu options, wherein said popularity for each one of said menu options is associated to the number of times said one menu option was selected for a period of time, and wherein at least one predictive menu option is provided in said telephone call based on said popularity of said menu options without requiring data to be input in said incoming call.
